(19) United States
(12) Patent Application Publication
(10) Pub. No.: US 2024/0086228 A1
(43) Pub. Date: Mar. 14, 2024

(54) Resource Configuration Method and Apparatus, Electronic Device, and Computer-Readable Storage Medium

(71) Applicant: Hangzhou AliCloud Feitian Information Technology Co., Ltd., Hangzhou (CN)

(72) Inventor: XIAOKANG HU, Hangzhou (CN)

(21) Appl. No.: 18/518,277

(22) Filed: Nov. 22, 2023

Related U.S. Application Data
(63) Continuation of application No. PCT/CN2022/093506, filed on May 18, 2022.

(30) Foreign Application Priority Data
May 25, 2021 (CN) 202110574518

(51) Int. Cl. G06F 9/455

(52) U.S. Cl. CPC G06F 9/45558; G06F 2009/4557

(57) ABSTRACT

A method and an apparatus are provided. The method includes: obtaining first computing resources of a first virtual machine; receiving a computing resource switching instruction, wherein the computing resource switching instruction instructs to switch at least one computing core of the first virtual machine to a second virtual machine for use; determining a computing core to be switched and a corresponding first thread in the first computing resources according to the computing resource switching instruction and the first computing resources; and switching the first thread to run the second virtual machine. In the present disclosure, when computing resources are switched between first virtual machine and the second virtual machine, which solves the problem of synchronizing the settings of two virtual machines in the existing technologies due to adjustment of binding core settings of the original virtual machine, which greatly reduces the complexity of management and control, and realizes privacy isolation.

### CROSS REFERENCE TO RELATED PATENT APPLICATIONS

This application claims priority to and is a continuation of PCT Patent Application No. PCT/CN2022/093506 filed on 18 May 2022, and is related to and claims priority to Chinese Application No. 202110574518.6, filed on 25 May 2021 and entitled “Resource Configuration Method and Apparatus, Electronic Device, and Computer-Readable Storage Medium,” which are incorporated herein by reference in their entirety.

### TECHNICAL FIELD

The present disclosure relates to the technical field of virtualization, and in particular to resource configuration methods and apparatuses, electronic devices, and computer-readable storage media.

### BACKGROUND

In mainstream virtualization scenarios (such as KVM), a user mode is responsible for creating and managing virtual machines. Each virtual machine exists in a form of a process in the Linux system. Each vCPU of such virtual machine corresponds to a thread in a virtual machine process, called as a vCPU thread. When a vCPU thread of the user-mode is running, a non-root mode of a processor is entered to run virtual machine codes. When the virtual machine executes privileged instructions, the non-root mode is quit for processing or simulation. For widely used dedicated virtual machine instances, each vCPU thread will exclusively run on a dedicated computing core.

When it is necessary to split a part of CPU computing resources from an existing virtual machine instance for use by other systems (such as building a new confidential virtual machine), a part of CPU is usually offline within the virtual machine to provide physical computing core resources to a target system for running.

In existing technologies, firstly, resource overhead is increased due to the introduction of new vCPU threads. Secondly, because binding settings between offline vCPU threads of the original virtual machine and corresponding computing cores are reused when creating new vCPU threads, that is, two computing cores x and y still reuse virtual machine A's settings of cores and threads. Therefore, when the binding settings of the original virtual machine A are adjusted later, the two cores x and y that have been lent to virtual machine B also need to be adjusted synchronously by virtual machine B to adapt to the new settings of virtual machine A, thus increasing the complexity of management and control. Finally, if virtual machine A suffers a malicious attack, split vCPUs (that is, vCPU-x threads and vCPU-y threads) may be forced to go online, and run on the same computing cores with the vCPU threads of virtual machine B, with side-channel attacks being used to spy on the privacy of virtual machine B.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or processor-readable/computer-readable instructions as permitted by the context above and throughout the present disclosure.

Embodiments of the present disclosure provide resource configuration methods and apparatuses, electronic devices, and computer-readable storage media to solve the defects in the existing technologies that switching resources between two virtual machines requires the creation of a new thread.

To achieve the above objectives, the embodiments of the present disclosure provide a resource configuration method, which includes:
obtaining a first computing resource of a first virtual machine, wherein the first computing resource includes at least one computing core currently used by first virtual machine and a first thread running on the computing core;
receiving a computing resource switching instruction, wherein the computing resource switching instruction instructs to switch the at least one computing core of the first virtual machine to a second virtual machine for use;
determining a computing core to be switched and a corresponding first thread in the first computing resource according to the computing resource switching instruction and the first computing resource; and
switching the first thread to run the second virtual machine.

The embodiments of the present disclosure also provide a resource configuration apparatus, which includes:

An acquisition module configured to obtain a first computing resource of a first virtual machine, wherein the first computing resource includes at least one computing core currently used by first virtual machine And a first thread running on the computing core;
a receiving module configured to receive a computing resource switching instruction, wherein the computing resource switching instruction instructs to switch the at least one computing core of the first virtual machine to a second virtual machine for use;
a determination module configured to determine a computing core to be switched and a corresponding first thread in the first computing resource according to the computing resource switching instruction and the first computing resource; and
a switching module configured to switch the first thread to run the second virtual machine.

The embodiments of the present disclosure also provides an electronic device, which includes:
a memory configured to store a program;
a processor is configured to run the program stored in the memory, and execute the resource configuration method provided by the embodiments of the present disclosure when the program runs.

The embodiments of the present disclosure also provide a computer-readable storage medium on which a computer program that is executable by a processor is stored, wherein when the program is executed by the processor, the resource configuration method provided by the embodiments of the present disclosure is implemented.

The resource configuration method and apparatus, electronic device and computer-readable storage medium provided by the embodiments of the present disclosure switch a thread running on a computing core to be switched for use by the second virtual machine to run the second virtual machine according to a computing resource switching instruction and computing resources of a first virtual machine. Therefore, when switching computing resources between first virtual machine And the second virtual machine, a binding relationship between the computing core and the thread is retained, which solves the problem of synchronizing the settings of two virtual machines in the existing technologies due to adjustment of binding core settings of the original virtual machine, which greatly reduces the complexity of management and control. Also, since no new threads are created during the resource switching process of the two virtual machines, this realizes mutually exclusive operations when two virtual machines respectively occupy the same thread, thereby realizing privacy isolation.

The above description is only an overview of the technical solutions of the present disclosure. In order to have a clearer understanding of the technical means of the present disclosure, they can be implemented according to the content of the disclosure. Moreover, in order to make the above and other purposes, features and advantages of the present disclosure more obvious and understandable, specific implementation methods of the present disclosure are specifically listed below.

### BRIEF DESCRIPTION OF THE DRAWINGS

Various other advantages and benefits will become apparent to one of ordinary skill in the art upon reading the following detailed description of preferred embodiments. Accordingly drawings are intended for illustrating the preferred embodiments only and are not to be construed as limitations to the present disclosure. Also, in the drawings, the same reference characters are used to designate the same components. In the drawings:

FIG. 1a is a schematic diagram of the principle of a resource configuration solution according to the existing technologies.

FIG. 1b is a schematic diagram of an application scenario of a resource configuration solution provided by the embodiments of the present disclosure.

FIG. 2 is a flowchart of an exemplary resource configuration method provided by the present disclosure.

FIG. 3 is a flowchart of another exemplary resource configuration method provided by the present disclosure.

FIG. 4 is a schematic structural diagram of an exemplary resource allocation apparatus provided by the present disclosure.

FIG. 5 is a schematic structural diagram of an exemplary electronic device provided by the present disclosure.

### DETAILED DESCRIPTION

Exemplary embodiments of the present disclosure will be described in more detail below with reference to the accompanying drawings. Although the drawings illustrate exemplary embodiments of the present disclosure, it should be understood that the present disclosure may be implemented in various forms and should not be limited to the embodiments set forth herein. Rather, these embodiments are provided to provide a thorough understanding of the disclosure, and to fully convey the scope of the present disclosure to one skilled in the art.

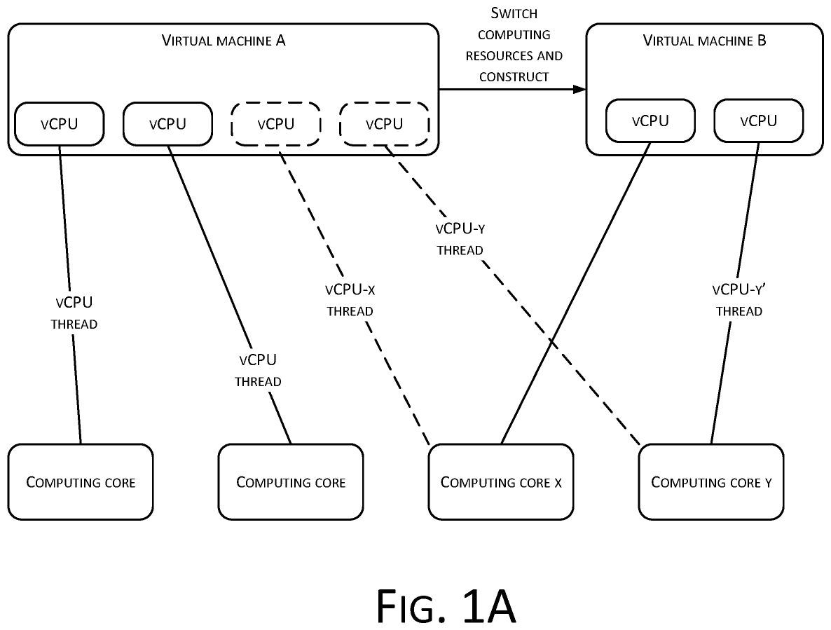

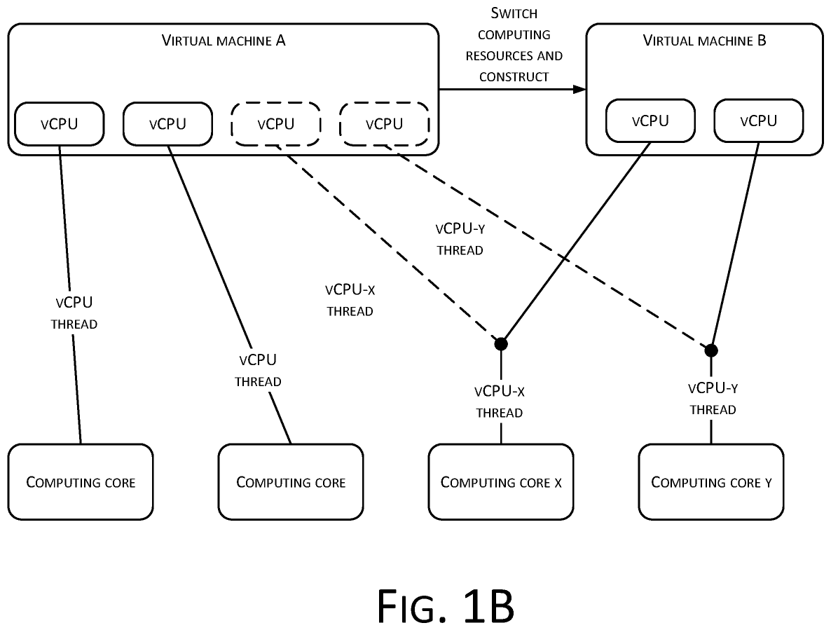

The solutions provided by the embodiments of the present disclosure can be applied to any system with resource configuration capabilities, such as a computing system including multiple virtual machines, etc. FIG. 1b is a schematic diagram of an application scenario of a resource configuration solution provided by the embodiments of the present disclosure. The scenario shown in FIG. 1b is only one example of the principles of the technical solutions of the present disclosure.

With the development of virtual computing technology, people can use limited physical computing resources to perform more flexible computing tasks. For example, in mainstream virtualization scenarios (such as KVM), a user mode is responsible for creating and managing virtual machines. Each virtual machine exists in a form of a process in the Linux system. Such virtual machine can have multiple vCPUs (virtual central processing units), and each vCPU can run on a thread in a virtual machine process, which is called as a vCPU thread. When a vCPU thread of the user mode is running, a non-root mode of a processor is entered to run virtual machine codes. When the virtual machine executes privileged instructions, the non-root mode is quit for processing or simulation. For widely used dedicated virtual machine instances, each vCPU thread will exclusively run on a dedicated computing core.

In this case, a virtual machine is usually created according to the needs of the current computing task or the needs of virtual machine planning. For example, as shown in FIG. 1a, FIG. 1a is a schematic diagram of the principle of a resource configuration solution in the existing technologies. Machine A is previously created based on execution of one or more computing requirements, and may have four vCPUs. Each vCPU may run on a vCPU thread, and each vCPU thread may be associated with actual physical computing resources, for example, binding with computing cores shown in FIG. 1a. Therefore, virtual machine A or its four vCPUs can run on these four computing cores through their respective vCPU threads. Later, as computing tasks are executed, the specification of the currently created virtual machine A will appear, that is, the utilization rate of the four vCPUs is not saturated. Therefore, computing resources can be segmented from the existing virtual machine A, that is, part of the CPU computing resources are used by other systems (such as building a new virtual machine). In this case, a part of the CPU is usually offline within virtual machine A to free up physical computing core resources for a target system to run.

For example, in the schematic diagram of the existing technologies as shown in FIG. 1a, when virtual machine A needs to free up computing cores x and y corresponding to two threads vCPU-x and vCPU-y, that is, the two vCPUs of virtual machine A running on the two threads vCPU-x and vCPU-y have no computing tasks for the time being in this case, they can be temporarily removed from virtual machine A to create a new virtual machine B, in order to improve the utilization rate of the computing cores x and y. To this end, in the existing technologies as shown in FIG. 1a, virtual machine A can first take the two virtual machines vCPU-x and vCPU-y offline, for example, marking them as unavailable, and at the same time make the two threads—vCPU-x thread and vCPU-y thread—to enter a sleep state. As such, these two threads are unbounded from the physical computing cores x and y. In this way, the computing cores that originally run computing tasks on vCPU-x and vCPU-y of virtual machine A are separated from the management of virtual machine A, and become computing resources that are freely allocable. For example, they can be used to create a new virtual machine B.

At this time, virtual machine B can create its own thread to use the spare computing cores x and y. When creating a thread, the virtual machine usually needs to set a binding relationship between the thread and the corresponding computing core. However, since virtual machine B directly uses the offline computing core of virtual machine A, virtual machine B can, for example, directly reuse the vCPU-x thread and the vCPU-y thread of virtual machine A and corresponding binding settings of the computing core x and the computing core y to set vCPU-x′ thread and vCPU-y′ thread created therefor.

However, in this case, since the new vCPU-x′ thread and the new vCPU-y′ thread are created for virtual machine B in the above process of creating virtual machine B, resource overhead is increased. Moreover, when creating the new vCPU-x′ thread and the new vCPU-y′ thread, binding settings of the offline vCPU threads of the original virtual machine A and the corresponding computing cores are reused, that is, the two computing cores x and y still reuse settings of cores and threads of virtual machine A. Therefore, when the binding settings of the original virtual machine A are adjusted later, virtual machine B also need to be responsible for synchronously adjusting these two cores x and y that have been lent to virtual machine B to adapt to the new settings of virtual machine A. In other words, virtual machine A needs to forward the adjusted settings to virtual machine B, and virtual machine B needs to depend on the current execution of computing tasks of its vCPU-x′ thread and vCPU-y′ thread to modify its binding settings of threads and cores, for example, waiting until the end of the current cycle, thus increasing the complexity of management and control. In addition, in the existing technologies as shown in FIG. 1a, when transferring computing resources to virtual machine B, virtual machine A only puts the vCPU-x thread and the vCPU-y thread into a sleep state instead of killing them completely. Therefore, if, for example, virtual machine A suffers a malicious attack and directly forces these two vCPU-x thread and vCPU-y thread that have entered the dormant state online without virtual machine B completing the operation of returning computing cores x and y, or the vCPU-x thread and the vCPU-y thread of virtual machine A are directly brought online (that is, bound to computing core x and computing core y) even when virtual machine B is still using computing cores x and y, the threads of virtual machine A and virtual machine B are bound to computing cores x and y at the same time in this case. In other words, the vCPU threads of virtual machine A and virtual machine B share and run on the same computing cores, and thus an attacker maliciously attacking virtual machine A can use a side channel attack to spy on the privacy of virtual machine B.

To this end, the embodiments of the present disclosure propose a resource configuration method. For example, as shown in FIG. 1b, in the resource configuration solutions of the embodiments of the present disclosure, when virtual machine A needs to release computing core x and computing core y to switch them to virtual machine B for use, virtual machine A can still take two virtual processors vCPU-x and vCPU-y offline, and mark them as unavailable, for example. After that, unlike the existing technologies, according to the embodiments of the present disclosure, virtual machine A does not put these two threads—vCPU-x thread and vCPU-y thread—into a sleep state, but directly allocates these two threads to virtual machine B for use, while maintaining binding relationships with the physical computing cores x and y. Therefore, the computing cores that originally ran computing tasks on vCPU-x and vCPU-y of virtual machine A are separated from the management of virtual machine A and used by virtual machine B, for example, used by two virtual processors of virtual machine B. Therefore, in this case, since vCPU-x thread (corresponding to computing core x) and vCPU-y thread (corresponding to computing core y) of virtual machine A are directly switched to and used by virtual machine B, reusing the binding settings between threads and computing cores after switching in the existing technologies is skipped.

In addition, according to the embodiments of the present disclosure, after the vCPU-x thread and vCPU-y thread of virtual machine A are switched to be used by virtual machine B, a running identifier can be additionally configured for each thread to identify which virtual machine the thread is currently running for. For example, as shown in FIG. 1b, after switching, running identifiers can respectively be set for the vCPU-x thread and the vCPU-y thread that have been switched to and used by virtual machine B to identify the virtual machine that these two threads are currently running for is virtual machine B. Therefore, after each calculation cycle is ended, virtual machine B can first check the running identifier on each thread to determine which virtual machine is to be run. For example, after switching to virtual machine B, the running identifier on each of the two threads—vCPU-x thread and vCPU-thread—can be set to B, to identify that virtual machine B is currently running. After virtual machine B finishes executing the current calculation cycle, a user mode may first be entered, for example, to check the running identifiers before executing the next calculation cycle. If the running identifier still identifies virtual machine B, virtual machine B can continue to use these two threads—vCPU-x thread and vCPU-thread—to execute the next calculation cycle. However, if virtual machine A needs to use these two threads when virtual machine B executes the current calculation cycle, the running identifiers of these two threads can be modified according to the usage request of virtual machine A. For example, as shown in FIG. 1b, when virtual machine A needs to reclaim these two threads, the running identifiers of these two threads can be modified to identify virtual machine A while virtual machine B executes the current calculation cycle, so that a determination can be made that the two threads need to be returned to virtual machine A after virtual machine B finishes executing the current calculation cycle by checking the running identifiers of the two threads. As such, the next calculation cycle of virtual machine B can be terminated, and virtual machine B is stopped to run on two threads. In addition, when virtual machine A only needs to use these two threads temporarily, for example, needing to perform synchronization operations, etc., it can only stop the two threads used by virtual machine B from running virtual machine B, and re-match these two threads with virtual machine A, so that virtual machine A can use these two threads to perform required operations. Furthermore, after performing the required operations, these two threads can be returned to virtual machine B again. However, during this process, since virtual machine A only temporarily uses these two threads, the running identifiers on these two threads—vCPU-x thread and vCPU-y thread—remain unchanged. Therefore, after virtual machine A finishes using these two threads and releases these two threads, virtual machine B can determine again that these two threads will be used by itself by checking the running identifiers on these two threads. Therefore, these two threads are switched to virtual machine B in the next calculation cycle.

The resource configuration solutions provided by the embodiments of the present disclosure switch a thread that is running on a computing core and to be switched to a second virtual machine to run the second virtual machine according to a computing resource switching instruction and computing resources of a first virtual machine. As such, when switching computing resources between first virtual machine And the second virtual machine, a binding relationship between the computing core and the thread is retained, which solves the problem of synchronizing settings of two virtual machines caused by adjusting binding core settings of the original virtual machine in the existing technologies. This greatly reduces the complexity of management and control. Since no new threads are created during a resource switching process of two virtual machines, this achieves an implementation of mutually exclusive operations of the two virtual machines that occupy the same thread respectively, thereby realizing privacy isolation.

The resource configuration solutions according to the embodiments of the present disclosure can not only reduce the complexity of management and control, but also achieve privacy isolation during virtual machine switching. Therefore, they can be applied to e-commerce platforms, for example, to improve the efficiency of management while avoiding the leakage of customer information. For example, the resource configuration solutions of the present disclosure can be applied to a virtual machine system that building an e-commerce platform. For example, virtual machine A in a virtual machine system can be used to run tenant A's e-commerce platform. When tenant B also uses such virtual machine system to perform its own tasks, a management module of the virtual machine system discovers that tenant A does not have many tasks at that time based on virtual machine A's operating status found, and the four computing cores occupied by virtual machine A are still available, that is, computing core x is idle. Therefore, the virtual machine system can make virtual machine A offline from a thread x corresponding to computing core x using the resource configuration solutions according to the embodiments of the present disclosure mentioned above, and assign thread x of computing core x to tenant B. For example, a virtual machine can be created for tenant B to use thread x, or thread x is added to the resources of tenant B's original virtual machine to run tenant B's tasks. Therefore, since the resource configuration solutions according to the embodiments of the present disclosure are performed in a mutually exclusive manner when switching threads to different virtual machines, that is, when switching thread x of computing core x to tenant B for use, tenant A's e-commerce platform originally running on thread x of computing core x has been made offline. Therefore, the data of tenant A's e-commerce platform no longer exists on thread x. Therefore, when using thread x, tenant B also cannot see any data of tenant A's e-commerce platform due to residual data. Particularly, in the embodiments of the present disclosure, in an event that tenant A needs to retrieve the thread x because the amount of tasks of its operating e-commerce platform sharply increases, as the resource configuration solutions according to the embodiments of the present disclosure only allow running a virtual machine in a mutually exclusive manner, the management module of the virtual machine system can interrupt tenant B from executing its task when tenant A needs to retrieve thread x, and take tenant B's task offline from thread x. In this way, the data of tenant B disappears from thread x. Therefore, when thread x runs tenant A's e-commerce platform again, tenant A's e-commerce platform cannot obtain the data of tenant B that was previously run in thread x. Therefore, the resource configuration solutions according to the embodiments of the present disclosure can help a virtual machine system running an e-commerce platform to realize flexible management and control of resources, and can also ensure the security of data on the e-commerce platform when switching virtual machine resources.

The resource configuration solutions according to the embodiments of the present disclosure can not only reduce the complexity of management and control, but also achieve privacy isolation during virtual machine switching. Therefore, they can be applied to telecommunications services, for example, to improve the efficiency of management while avoiding the leakage of customer information. For example, the resource configuration solutions of the present disclosure can be applied to a virtual machine system performing telecommunications services. For example, virtual machine A in a virtual machine system can be used to run tenant A's telecommunications services. When tenant B also uses such virtual machine system to perform its own tasks, a management module of the virtual machine system discovers that tenant A does not have many tasks at that time based on virtual machine A's operating status found, and the four computing cores occupied by virtual machine A are still available, that is, computing core x is idle. Therefore, the virtual machine system can make virtual machine A offline from a thread x corresponding to computing core x using the resource configuration solutions according to the embodiments of the present disclosure mentioned above, and assign thread x of computing core x to tenant B. For example, a virtual machine can be created for tenant B to use thread x, or thread x is added to the resources of tenant B's original virtual machine to run tenant B's tasks. Therefore, since the resource configuration solutions according to the embodiments of the present disclosure are performed in a mutually exclusive manner when switching threads to different virtual machines, that is, when switching thread x of computing core x to tenant B for use, tenant A's telecommunications services originally running on thread x of computing core x has been made offline. Therefore, tenant A's telecommunications services that previously ran, especially user data, no longer exist on thread x. Therefore, when using thread x, tenant B also cannot see any data of tenant A's telecommunications services due to residual data. Particularly, in the embodiments of the present disclosure, in an event that tenant A needs to retrieve the thread x because the amount of tasks of its operating telecommunications services sharply increases, as the resource configuration solutions according to the embodiments of the present disclosure only allow running a virtual machine in a mutually exclusive manner, the management module of the virtual machine system can interrupt tenant B from executing its task when tenant A needs to retrieve thread x, and take tenant B's task offline from thread x. In this way, the data of tenant B disappears from thread x. Therefore, when thread x runs tenant A's telecommunications services again, tenant A's telecommunications services cannot obtain the data of tenant B that was previously run in thread x. Therefore, the resource configuration solutions according to the embodiments of the present disclosure can help a virtual machine system running telecommunications services to realize flexible management and control of resources, and can also ensure the security of data on the telecommunications services when switching virtual machine resources.

Since the resource configuration solutions according to the embodiments of the present disclosure can reduce the complexity of management and control, they can be applied to, for example, audio and video processing to improve the efficiency of processing. For example, the resource configuration solutions of the present disclosure can be applied to a virtual machine system that performs audio and video processing. For example, virtual machine A in a virtual machine system can be used to process audio and video files for tenant A, such as on-demand or streaming media, etc. When tenant B also uses the virtual machine system to perform its own tasks, a management module of the virtual machine system discovers that tenant A currently does not need to process much audio and video data according to the running status of virtual machine A, and the four computing cores occupied by virtual machine A are still available, for example, computing core x is idle. Therefore, the virtual machine system using the resource configuration solutions of the present disclosure can make virtual machine A offline from thread x corresponding to computing core x as described above, and allocate thread x of computing core x to tenant B, for example, creating a virtual machine tenant B to use thread x or adding thread x to original virtual machine resources of tenant B. Therefore, tenant A actually only uses three computing cores of the virtual machine system from the moment of switching. When billing tenant A, the resource usage fees for tenant A can therefore be reduced accordingly. If an agreement is reached between tenant A and tenant B, tenant A may even rent its computing core x to tenant B for temporary use. This not only improves the utilization rate of computing resources in the virtual machine system, but also maintains the binding relationships between computing cores and threads when switching threads to different virtual machines according to the resource configuration solutions according to the embodiments of the present disclosure. Therefore, for tenant A, it is extremely convenient to release a thread to tenant B and to retrieve the thread for continuous use when its workload increases. No special settings and management are required, thus increasing the efficiency of management of switching of computing resources between tenants, that is, virtual machines.

Since the resource configuration solutions according to the embodiments of the present disclosure can reduce the complexity of management and control, they can be applied to, for example, artificial intelligence computing to improve the efficiency of processing. Artificial intelligence computing usually requires a large amount of computing resources. Therefore, the resource configuration solutions of the present disclosure can be applied to a virtual machine system that performs artificial intelligence processing. For example, virtual machine A in a virtual machine system can be used to perform artificial intelligence tasks for tenant A, such as model training, etc. When tenant B also uses the virtual machine system to perform its own tasks, a management module of the virtual machine system discovers that tenant A currently does not have many artificial intelligence computing tasks according to the operating status of virtual machine A, and the four computing cores occupied by virtual machine A are still available. for example, computing core x is idle. Therefore, the virtual machine system using the resource configuration solutions of the present disclosure can make virtual machine A offline from thread x corresponding to computing core x as described above, and allocate thread x of computing core x to tenant B, for example, creating a virtual machine tenant B to use thread x or adding thread x to original virtual machine resources of tenant B. Therefore, tenant A actually only uses three computing cores of the virtual machine system from the moment of switching. When billing tenant A, the resource usage fees for tenant A can therefore be reduced accordingly. If an agreement is reached between tenant A and tenant B, tenant A may even rent its computing core x to tenant B for temporary use. This not only improves the utilization rate of computing resources in the virtual machine system, but also maintains the binding relationships between computing cores and threads when switching threads to different virtual machines according to the resource configuration solutions according to the embodiments of the present disclosure. Therefore, for tenant A, it is extremely convenient to release a thread to tenant B and to retrieve the thread for continuous use when its workload increases. No special settings and management are required, thus increasing the efficiency of management of switching of computing resources between tenants, that is, virtual machines.

Since the resource allocation solutions according to the embodiments of the present disclosure can reduce the complexity of management and control, they can be applied to, for example, an online ticketing platform to improve the efficiency of processing. In particular, the degree of busyness of online ticket sales depends largely on the performance or timing of the tickets to be sold, such as holidays, etc. Therefore, the resource configuration solutions of the present disclosure can be applied to a virtual machine system running an online ticketing platform. For example, virtual machine A in a virtual machine system can be used to run an online ticket sales platform for tenant A, etc. When tenant B also uses this virtual machine system to perform its own tasks, and when that day is the start day of ticket sales for holidays or when the tickets to be sold on that day are for popular programs, virtual machine A finds that the current computing resources are insufficient to handle a sharp increase in user requests for purchasing a ticket. Therefore, a management module of the virtual machine system can allocate one or more computing cores from virtual machine B to virtual machine A for virtual machine A to use based on virtual machine A's request. For example, the virtual machine system using the resource allocation solutions according to the embodiments of the present disclosure can temporarily make thread x and thread y corresponding to computing core x and computing core y that are to be allocated from virtual machine B and used by virtual machine A offline as described above, and allocate thread x of computing core x and thread y of computing core y to tenant A for use, that is, thread x and thread y are directly added to the original virtual machine resources of tenant A. Therefore, through the resource configuration solutions of the present disclosure, when virtual machine A needs a temporary thread, it only needs to make a corresponding virtual machine offline from that thread, and the thread directly runs virtual machine A after the thread is offline. This not only improves the utilization rate of computing resources in the virtual machine system, but also improves the switching efficiency because binding relationships between computing cores and threads are maintained when switching threads to different virtual machines according to the resource configuration solutions of the embodiments of the present disclosure. This can effectively handle the sudden surge in the amount of tasks of the online ticketing platform, which requires a large amount of temporary computing resources.

The above embodiments are illustrative of the technical principles and exemplary application frameworks of the embodiments of the present disclosure. Specific technical solutions of the embodiments of the present disclosure will be further described in detail through multiple embodiments below.

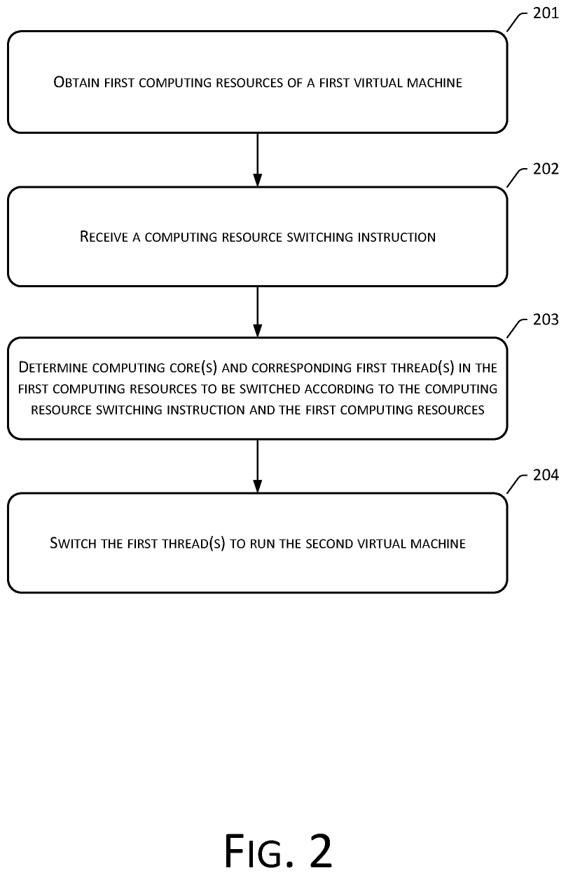

FIG. 2 is a flowchart of an example resource configuration method provided by the present disclosure. An execution subject of this method can be various terminals or server devices with resource configuration capabilities, or can be devices or chips integrated on these devices. As shown in FIG. 2, the resource configuration method includes the following steps:

S201: Obtain first computing resources of a first virtual machine.

In the embodiments of the present disclosure, computing resources of a first virtual machine that is currently running can be obtained during the running of the virtual machine. In particular, the present disclosure relates to configuring computing resources used by virtual machines between two or more virtual machines. For example, as shown in FIG. 1b, a resource allocation is performed between virtual machine A that is currently running and a newly created virtual machine B. To this end, in step S201, first computing resources of a first virtual machine may be obtained first. Such first computing resources may include computing core(s) currently being used by first virtual machine And first thread(s) running on the computing core(s). For example, as shown in FIG. 1b, the currently running first virtual machine may be virtual machine A, and the first computing resources may be four threads of four CPUs that run virtual machine A and four physical computing cores that are bound with the threads one by one. These computing resources can form the basis for future resource configuration between virtual machine A and virtual machine B.

S202: Receive a computing resource switching instruction.

When virtual machine A is running, due to, for example, changes in computing tasks of virtual machine A, part of the computing resources of virtual machine A can be transferred to other virtual machines, such as virtual machine B as shown in FIG. 1b. To this end, in step S202, a computing resource switching instruction for resources transferred out from the current virtual machine A may be received. For example, the computing resource switching instruction received in step S202 may indicate switching at least one computing core of a first virtual machine, such as virtual machine A shown in FIG. 1b, to a second virtual machine, such as virtual machine B, for use.

S203: Determine computing core(s) and corresponding first thread(s) in the first computing resources to be switched according to the computing resource switching instruction and the first computing resources.

After receiving the computing resource switching instruction in step S202, computing core(s) in the first computing resources of the first virtual machine, such as virtual machine A, that need(s) to be switched to the second virtual machine may be determined based on the computing resource switching instruction in step S203 and the obtained in step S201. For example, the computing resource switching instruction received in step S202 may be to switch two of the four threads and their four corresponding computing cores used by virtual machine A to virtual machine B, and to determine that vCPU-x thread and vCPU-y thread are currently idle and are transferable computing resources based on statuses of the threads and the computing cores in the first computing resources obtained in step S201. Therefore, in step S203, a determination can be made to switch vCPU-x thread and vCPU-y thread to virtual machine B for use.

S204: Switch the first thread(s) to run the second virtual machine.

After determining in step S203 that vCPU-x thread and vCPU-y thread are to be switched to virtual machine B, in step S204, the first thread(s) determined in step S203, for example, vCPU-x thread and vCPU-y thread are released from the use relationship with the first virtual machine, and the second virtual machine, such as virtual machine B, is run on these two threads.

The resource configuration method provided by the embodiments of the present disclosure switches a thread running on a computing core to be switched to a second virtual machine to run a second virtual machine according to a computing resource switching instruction and computing resources of a first virtual machine. As such, when switching computing resources between first virtual machine And the second virtual machine, a binding relationship between the computing core and the thread is retained, which solves the problem of synchronizing the settings of two virtual machines in the existing technologies due to adjustment of binding core settings of the original virtual machine, which greatly reduces the complexity of management and control. Also, since no new threads are created during the resource switching process of the two virtual machines, this realizes mutually exclusive operations when two virtual machines respectively occupy the same thread, thereby realizing privacy isolation.

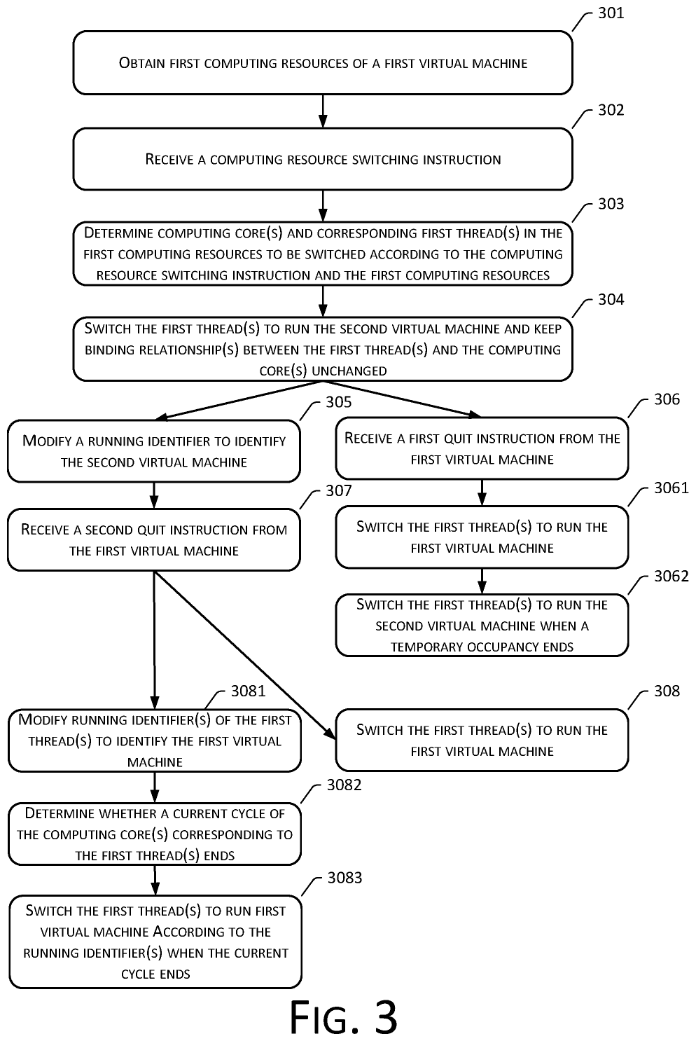

FIG. 3 is a flowchart of another example resource configuration method provided by the present disclosure. An execution subject of the method may be various terminals or server devices capable of resource configuration, or devices or chips integrated on these devices. As shown in FIG. 3, the resource allocation method includes the following steps:

S301: Obtain first computing resources of a first virtual machine.

In the embodiments of the present disclosure, computing resources of a first virtual machine that is currently running can be obtained during the running of the virtual machine. In particular, the present disclosure relates to configuring computing resources used by virtual machines between two or more virtual machines. For example, as shown in FIG. 1b, a resource allocation is performed between virtual machine A that is currently running and a newly created virtual machine B. To this end, in step S301, first computing resources of a first virtual machine may be obtained first. Such first computing resources may include computing core(s) currently being used by first virtual machine And first thread(s) running on the computing core(s). For example, as shown in FIG. 1b, the currently running first virtual machine may be virtual machine A, and the first computing resources may be four threads of four CPUs that run virtual machine A and four physical computing cores that are bound with the threads one by one. These computing resources can form the basis for future resource configuration between virtual machine A and virtual machine B.

S302: Receive a computing resource switching instruction.

When virtual machine A is running, due to, for example, changes in computing tasks of virtual machine A, part of the computing resources of virtual machine A can be transferred to other virtual machines, such as virtual machine B as shown in FIG. 1b. To this end, in step S302, a computing resource switching instruction for resources transferred out from the current virtual machine A may be received. For example, the computing resource switching instruction received in step S302 may indicate switching at least one computing core of a first virtual machine, such as virtual machine A shown in FIG. 1b, to a second virtual machine, such as virtual machine B, for use.

S303: Determine computing core(s) and corresponding first thread(s) in the first computing resources to be switched according to the computing resource switching instruction and the first computing resources.

After receiving the computing resource switching instruction in step S302, computing core(s) in the first computing resources of the first virtual machine, such as virtual machine A, that need(s) to be switched to the second virtual machine may be determined based on the computing resource switching instruction in step S303 and the obtained in step S301. For example, the computing resource switching instruction received in step S302 may be to switch two of the four threads and their four corresponding computing cores used by virtual machine A to virtual machine B, and to determine that vCPU-x thread and vCPU-y thread are currently idle and are transferable computing resources based on statuses of the threads and the computing cores in the first computing resources obtained in step S301. Therefore, in step S303, a determination can be made to switch vCPU-x thread and vCPU-y thread to virtual machine B for use.

S304: Switch the first thread(s) to run the second virtual machine and keep binding relationship(s) between the first thread(s) and the computing core(s) unchanged.

After determining that vCPU-x thread and vCPU-y thread are to be switched to virtual machine B in step S303, in step S304, the first thread determined in step S203, for example, vCPU-x thread and vCPU-y thread are released from the first virtual machine, and a second virtual machine, such as virtual machine B, is run on these two threads. Moreover, at the same time, binding relationships between these vCPU-x thread and vCPU-y thread and corresponding computing cores x and y are maintained. Therefore, second virtual machine B can directly run its computing tasks, such as its vCPU-x′ and vCPU-y′, without performing any binding settings between threads and computing cores.

In step S304, when the two threads—vCPU-x thread and vCPU-y thread of first virtual machine A—are switched to second virtual machine B for use, in order to identify a virtual machine running by the current thread in the cycle, a running identifier is further configured for each of the two threads switched to identify which virtual machine the thread is currently running for. Therefore, the resource configuration method in the embodiments of the present disclosure may further include:

S305: Modify a running identifier to identify the second virtual machine.

Under the circumstance that each thread is set with a running identifier to indicate a virtual machine for which the respective thread is currently running, when virtual machine A configures vCPU-x thread and vCPU-y thread for use by virtual machine B as described above, running identifiers of these threads can be changed from A to B to indicate that these two threads have been switched to second virtual machine B for use. Thus, after virtual machine A or B has finished executing the current calculation cycle and before starting the next calculation cycle, the running identifiers can be checked first to determine by which virtual machine the threads will be used, or more specifically, which virtual processor of which virtual machine will use the threads.

For example, in step S304, vCPU-x thread and vCPU-y thread are switched to virtual machine B for use and in step S305, the running identifiers are modified to indicate that virtual machine B is currently running thereon. Then, after virtual machine B completes the current calculation cycle and before executing the next calculation cycle, a user mode can be entered to check the running identifiers. If the running identifiers still identify virtual machine B, this means that there are no additional instructions that these two threads are required to be used by other virtual machines during the execution of the previous calculation cycle by virtual machine B. Therefore, virtual machine B can continue to use these two threads, vCPU-x thread and vCPU-y thread, to execute the next calculation cycle. However, if virtual machine A needs to use these two threads when virtual machine B executes the current calculation cycle, the running identifiers of these two threads can be modified according to the usage request of virtual machine A. For example, the resource configuration method in the embodiments of the present disclosure may further include:

S306: Receive a first quit instruction from the first virtual machine.

In step S304, virtual machine A switches vCPU-x thread and vCPU-y thread to virtual machine B for use. So, virtual machine B can receive first virtual machine A's instruction in step S306 while using these two threads to perform its computing tasks, in order to add a response to virtual machine A's instruction when using the threads switched from virtual machine A. For example, virtual machine A may send a first quit instruction to virtual machine B, and the first quit instruction may indicate that first virtual machine A temporarily occupies the first thread(s). Specifically, virtual machine A needs to temporarily occupy the two threads that have been switched to be used by virtual machine B.

S3061: Switch the first thread(s) to run the first virtual machine.

S3062: Switch the first thread(s) to run the second virtual machine when a temporary occupancy ends.

Therefore, after finishing the execution of the current calculation cycle, virtual machine B can withdraw from these two threads according to the quit instruction received in step S306, and switch these two threads to first virtual machine A in step S3061. In particular, since virtual machine A temporarily occupies these threads, there is no need to modify the running identifiers (e.g., modifying to indicate virtual machine A) on the two threads in this case, and can remain to indicate virtual machine B. As such, after virtual machine A finishes executing the computing task during temporary occupancy, the two threads can be switched to run second virtual machine B again in step S3062.

S307: Receive a second quit instruction from the first virtual machine.

In addition, when virtual machine A needs to reclaim these two threads, virtual machine A can send a second quit instruction to virtual machine B. Thus, a second quit instruction can be received in step S307. The second quit instruction can, for example, indicate the first virtual machine to reclaim the first thread(s).

S308: Switch the first thread(s) to run the first virtual machine.

Therefore, virtual machine B can return the threads to virtual machine A for use according to an instruction of virtual machine A that indicates to reclaim the threads during the running period. In particular, when a running identifier is set on a thread,

Step S308 may further include:

S3081: Modify running identifier(s) of the first thread(s) to identify the first virtual machine.

S3082: Determine whether a current cycle of the computing core(s) corresponding to the first thread(s) ends.

S3083: Switch the first thread(s) to run first virtual machine According to the running identifier(s) when the current cycle ends.

For example, when virtual machine A needs to reclaim these two threads, the running identifiers of these two threads can be modified to identify virtual machine A while virtual machine B is executing the current calculation cycle. Therefore, after virtual machine B completes the current calculation cycle, a determination can be made that these two threads need to be returned to virtual machine A by checking the running identifiers on these two threads. As such, the next calculation cycle of virtual machine B can be terminated, and these two threads are stopped from running virtual machine B.

The resource configuration method provided by the embodiments of the present disclosure switches a thread running on a computing core to be switched to a second virtual machine to run a second virtual machine according to a computing resource switching instruction and computing resources of a first virtual machine. As such, when switching computing resources between first virtual machine And the second virtual machine, a binding relationship between the computing core and the thread is retained, which solves the problem of synchronizing the settings of two virtual machines in the existing technologies due to adjustment of binding core settings of the original virtual machine, which greatly reduces the complexity of management and control. Also, since no new threads are created during the resource switching process of the two virtual machines, this realizes mutually exclusive operations when two virtual machines respectively occupy the same thread, thereby realizing privacy isolation.

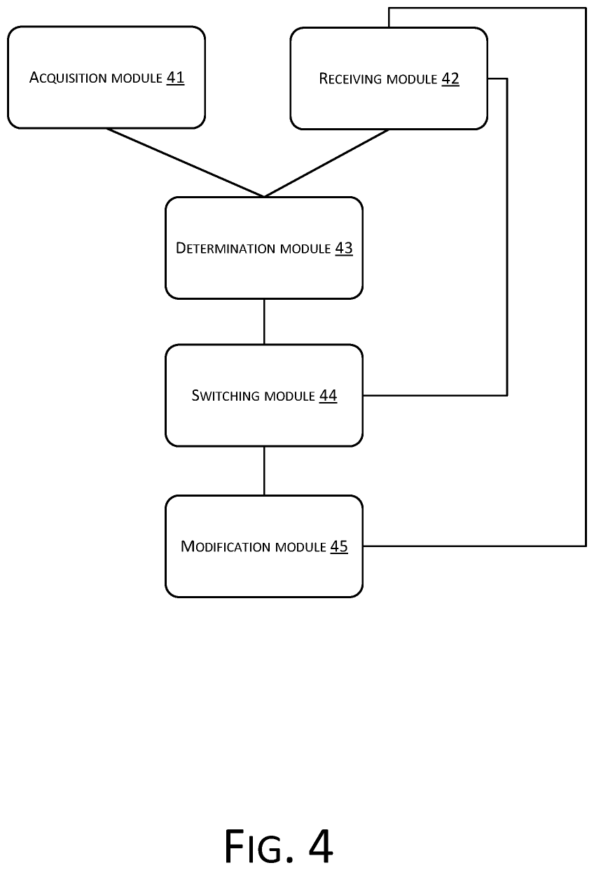

FIG. 4 is a schematic structural diagram of an example resource configuration apparatus provided by the present disclosure, which can be used to execute the method steps shown in FIG. 2 and FIG. 3. As shown in FIG. 4, the resource configuration apparatus may include: an acquisition module 41, a receiving module 42, a determination module 43 and a switching module 44.

The acquisition module 41 may be configured to obtain first computing resources of a first virtual machine.

In the embodiments of the present disclosure, computing resources of a first virtual machine that is currently running can be obtained during the running of the virtual machine. In particular, the present disclosure relates to configuration of computing resources used by virtual machines between two or more virtual machines. For example, as shown in FIG. 1b, a resource allocation is performed between virtual machine A that is currently running and a newly created virtual machine B. To this end, the acquisition module 41 may first obtain the first computing resources of the first virtual machine. The first computing resources may include computing core(s) currently being used by first virtual machine And first thread(s) running on the computing core(s). For example, as shown in FIG. 1b, the currently running first virtual machine may be virtual machine A, and the first computing resources may be four threads of four CPUs running virtual machine A and four physical computing cores that are bound to the threads one by one. These computing resources can form the basis for future resource configuration between virtual machine A and virtual machine B.

The receiving module 42 may be configured to receive a computing resource switching instruction.

When virtual machine A is running, due to changes in the computing tasks of virtual machine A, for example, part of the computing resources of virtual machine A can be transferred to other virtual machines, such as virtual machine B as shown in FIG. 1b. To this end, the receiving module 42 may receive a computing resource switching instruction for transferring resources of the current virtual machine A. For example, the computing resource switching instruction received by the receiving module 42 may indicate to switch at least one computing core of the first virtual machine, such as virtual machine A shown in FIG. 1b, to be used by the second virtual machine, such as virtual machine B.

The determination module 43 may be configured to determine computing core(s) and corresponding first thread(s) in the first computing resources to be switched according to the computing resource switching instruction and the first computing resources.

After the receiving module 42 receives the computing resource switching instruction, the determination module 43 may determine computing core(s) in the first computing resources of the first virtual machine (such as virtual machine A) that need(s) to be switched to the second virtual machine according to the computing resource switching instruction and the first computing resources obtained by the acquisition module 41. For example, the computing resource switching instruction received by the receiving module 42 may be to switch two of four threads and corresponding four computing cores used by virtual machine A to virtual machine B, and a determination can be made that vCPU-x thread and vCPU-y thread are currently in an idle state and belong to computing resources that are allocable based on the statuses of threads and computing cores in the first computing resources obtained by the acquisition module 41. Therefore, the determination module 43 can confirm that vCPU-x thread and vCPU-y thread are to be switched to virtual machine B for use.

The switching module 44 may be configured to switch the first thread(s) to run the second virtual machine.

After the determination module 43 determines that vCPU-x thread and vCPU-y thread are switched to virtual machine B, the switching module 44 can release usage relationship(s) of the first thread(s) determined by the determination module 43, for example, vCPU-x thread and vCPU-y thread, from the first virtual machine, and run the second virtual machine on these two threads, such as virtual machine B. Furthermore, the switching module 44 can maintain binding relationships of vCPU-x thread and vCPU-y thread with corresponding computing cores x and y at the same time, so that second virtual machine B can directly run its computing tasks, such as its vCPU-x′ and vCPU-y′, without performing any binding settings between threads and computing cores.

When the switching module 44 switches the two threads—vCPU-x thread and vCPU-y thread—first virtual machine A to second virtual machine B for use, in order to identify a virtual machine run by the current thread in the cycle, a running identifier can further be configured for each of these two threads switched to identify which virtual machines the threads are currently running for. Therefore, the resource configuration apparatus in the embodiments of the present disclosure may further include: a modification module 45, which may be configured to modify a running identifier to identify the second virtual machine.

In an event that each thread is provided with a running identifier to indicate a virtual machine currently run by the respective thread, when virtual machine A configures vCPU-x thread and vCPU-y thread to virtual machine B as mentioned above, the modification module 45 can modify running identifiers set on the threads from A to B to indicate that these two threads have been switched to second virtual machine B for use. Thus, after virtual machine A or B has finished executing the current calculation cycle and before starting the next calculation cycle, the running identifiers can first be checked to determine which virtual machine(s) will use these threads, or more specifically, which virtual processors of which virtual machine(s) will use these threads.

For example, the switching module 44 switches vCPU-x thread and the vCPU-y thread to virtual machine B, and the modification module 45 modifies the running identifiers to indicate that virtual machine B is currently running. After virtual machine B completes the current calculation cycle and before executing the next calculation cycle, a user mode can be entered to check the running identifiers. If the running identifiers still identify virtual machine B, this means that there is no additional instruction that these two threads are required to be used by another virtual machine during the execution of the previous calculation cycle by virtual machine B, so virtual machine B can continue to use these two threads—vCPU-x thread and vCPU-y thread- to perform the next calculation cycle. However, if virtual machine A needs to use these two threads while virtual machine B executes the current calculation cycle, the running identifiers of these two threads can be modified according to a usage request of virtual machine A. In the embodiments of the present disclosure, for example, the receiving module 42 may be further configured to detect a first quit instruction from the first virtual machine.

The switching module 44 switches vCPU-x thread and vCPU-y thread from virtual machine A to virtual machine B. As such, while virtual machine B uses these two threads to perform its computing tasks, the receiving module 42 can receive data from first virtual machine A to add a response to an instruction of virtual machine A during the use of the threads switched from virtual machine A. For example, virtual machine A may send a first quit instruction to virtual machine B, and the first quit instruction may indicate that first virtual machine A temporarily occupies the first thread(s), that is, virtual machine A needs to temporarily occupy the two threads that have been switched to be used by virtual machine B.

Therefore, the switching module 44 may be further configured to switch the first thread(s) to run the first virtual machine, and switch the first thread(s) to run the second virtual machine when a temporary occupancy ends.

Therefore, after virtual machine B finishes executing the current calculation cycle, the switching module 44 can switch the two threads to first virtual machine A according to the quit instruction received by the receiving module 42. In particular, since virtual machine A temporarily occupies thereof, in this case, it is not necessary for the modification module 45 to modify the running identifiers on these two threads, such as modifying to indicate virtual machine A, which can still remain as indicating virtual machine B. Therefore, after virtual machine A finishes executing computing task(s) during temporary occupancy, the two threads can be switched to run second virtual machine B again through the switching module 44.

The receiving module 42 may be further configured to receive a second quit instruction from the first virtual machine.

In addition, when needing to reclaim the two threads, virtual machine A can send a second quit instruction to virtual machine B. The receiving module 42 can thus receive the second quit instruction. The second quit instruction can indicate, for example, that the first virtual machine reclaims the first thread(s).

The switching module 44 may be further configured to switch the first thread(s) to run the first virtual machine.

Therefore, virtual machine B can return the threads to virtual machine A for use according to an instruction of virtual machine A that indicates to reclaim the threads during the running period. In particular, when the running identifiers are set on the threads,
the modification module 45 may be further configured to: modify the running identifier(s) of the first thread(s) to identify the first virtual machine.

The switching module 44 may be further configured to: determine whether a current cycle of the computing core(s) corresponding to the first thread(s) ends.

When the current cycle ends, the first thread(s) is/are switched to run the first virtual machine according to the running identifier(s).

For example, when virtual machine A needs to reclaim these two threads, the modification module 45 can modify the running identifiers of the two threads to identify virtual machine A during execution of the current calculation cycle of virtual machine B. Therefore, after virtual machine B executes the current calculation cycle, by checking the running identifiers on these two threads to confirm that the two threads need to be returned to virtual machine A, the next calculation cycle of virtual machine B can then be terminated, and these two threads are stopped from running virtual machine B.

The resource configuration apparatus provided by the embodiments of the present disclosure switches a thread running on a computing core to be switched to a second virtual machine to run a second virtual machine according to a computing resource switching instruction and computing resources of a first virtual machine. As such, when switching computing resources between first virtual machine And the second virtual machine, a binding relationship between the computing core and the thread is retained, which solves the problem of synchronizing the settings of two virtual machines in the existing technologies due to adjustment of binding core settings of the original virtual machine, which greatly reduces the complexity of management and control. Also, since no new threads are created during the resource switching process of the two virtual machines, this realizes mutually exclusive operations when two virtual machines respectively occupy the same thread, thereby realizing privacy isolation.

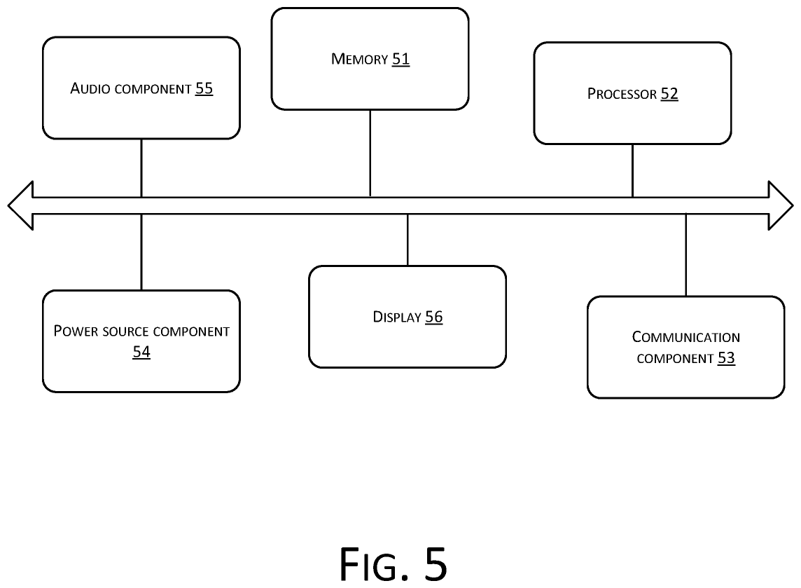

The internal functions and structures of the resource allocation apparatus are described above, and the apparatus can be implemented as an electronic device. FIG. 5 is a schematic structural diagram of an example electronic device provided by the present disclosure. As shown in FIG. 5, the electronic device includes a memory 51 and a processor 52.

The memory 51 is configured to store programs. In addition to the programs as described above, the memory 51 may also be configured to store other various data to support operations on the electronic device. Examples of such data include instructions for any applications or methods operating on the electronic device, contact data, phonebook data, messages, pictures, videos, etc.

The memory 51 may be implemented by any type of volatile or non-volatile storage device or a combination thereof, such as static random access memory (SRAM), electrically erasable programmable read-only memory (EEPROM), erasable programmable read-only memory (EEPROM), programmable read-only memory (EPROM), programmable read-only memory (PROM), read-only memory (ROM), magnetic memory, flash memory, magnetic or optical disk.

The memory 51 may include non-permanent storage in computer-readable media, random access memory (RAM), and/or non-volatile memory in a form of read-only memory (ROM) or flash memory (flash RAM). The memory 51 is an example of computer-readable media.

The computer-readable media includes both persistent and non-volatile, removable and non-removable media that can be implemented by any method or technology for storage of information. Information may be computer-readable instructions, data structures, modules of programs, or other data. Examples of computer storage media include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technology, compact disc read-only memory (CD-ROM), digital versatile disc (DVD) or other optical storage, magnetic tape cassettes, tape magnetic disk storage or other magnetic storage devices, or any other non-transmission medium can be used to store information that can be accessed by a computing device. As defined herein, computer-readable media does not include transitory media, such as modulated data signals and carrier waves.

The processor 52 is not limited to a central processing unit (CPU), but may also be a processing chip, such as a graphics processing unit (GPU), a field programmable gate array (FPGA), an embedded neural network processor (NPU) or an artificial intelligence (AI) chip, etc. The processor 52 is coupled to the memory 51, and executes the programs stored in the memory 51. When the programs are running, the resource allocation methods of the foregoing method embodiments are executed.

Further, as shown in FIG. 5, the electronic device may further include: a communication component 53, a power source component 54, an audio component 55, a display 56, and other components. FIG. 5 merely schematically shows some components, which does not mean that the electronic device only includes the components as shown in FIG. 5.

The communication component 53 is configured to facilitate wired or wireless communication between the electronic device and other devices. The electronic device can access wireless networks based on communication standards, such as WiFi, 3G, 4G or 5G, or a combination thereof. In an exemplary embodiment, the communication component 53 receives a broadcast signal or broadcast related information from an external broadcast management system via a broadcast channel. In an exemplary embodiment, the communication component 53 also includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology, and other technologies.

The power source component 54 provides power for various components of the electronic device. The power source component 54 may include a power management system, one or more power sources, and other components associated with generating, managing, and distributing power to the electronic device.

The audio component 55 is configured to output and/or input audio signals. For example, the audio component 55 includes a microphone (MIC) configured to receive external audio signals when the electronic device is in an operating mode, such as a call mode, a recording mode, and a voice recognition mode. The received audio signal may be further stored in the memory 51, or sent via the communication component 53. In some embodiments, the audio component 55 also includes a speaker for outputting audio signals.

The display 56 includes a screen, which may include a liquid crystal display (LCD) and a touch panel (TP). If the screen includes a touch panel, the screen may be implemented as a touch screen to receive input signals from a user. The touch panel includes one or more touch sensors to sense touches, swipes, and gestures on the touch panel. The touch sensor may not only sense the boundary of a touching or sliding action, but also detect the duration and pressure associated with the touching or sliding action.

One of ordinary skill in the art can understand that all or part of the steps to implement the foregoing method embodiments can be completed by hardware related to program instructions. The foregoing programs can be stored in a computer-readable storage medium. When the programs are executed, the steps including the above-mentioned method embodiments are executed. The storage medium include: ROM, RAM, a magnetic disk, an optical disk, and other media that can store program codes.

Finally, it needs to be noted that the above embodiments are only used to illustrate the technical solutions of the present disclosure, but not to meant to limit thereof. Although the present invention has been described in detail with reference to the foregoing embodiments, one of ordinary skill in the art should understand that: the technical solutions described in the foregoing embodiments can still be modified, or some or all of the technical features can be equivalently replaced. These modifications or replacements do not cause the essence of the corresponding technical solutions to deviate from the scope of the technical solutions of the embodiments of the present disclosure.

The present disclosure can be further understood using the following clauses.

Clause 1: A resource allocation method, comprising: obtaining first computing resources of a first virtual machine, wherein the first computing resources include at least one computing core currently used by the first virtual machine and first thread(s) running on the computing core; receiving a computing resource switching instruction, wherein the computing resource switching instruction instructs to switch the at least one computing core of the first virtual machine to a second virtual machine for use; determining a computing core to be switched and a corresponding first thread in the first computing resources according to the computing resource switching instruction and the first computing resources; and switching the first thread to run the second virtual machine.

Clause 2: The resource allocation method according to Clause 1, wherein the computing core has a binding relationship with the corresponding first thread, and switching the first thread to run the second virtual machine comprises: switching the first thread to run the second virtual machine and keeping the binding relationship between the first thread and the computing core unchanged.

Clause 3: The resource allocation method according to Clause 1, wherein the first thread is set with a running identifier, wherein the running identifier identifies a virtual machine that the first thread is currently running for, and after the first thread is switched to run the second virtual machine, the method further comprises: modifying the running identifier to identify the second virtual machine.

Clause 4: The resource configuration method according to Clause 3, further comprising: receiving a first quit instruction from the first virtual machine, wherein the first quit instruction indicates a temporary occupancy of the first thread by the first virtual machine; switching the first thread to run the first virtual machine; and switching the first thread to run the second virtual machine when the temporary occupancy ends.

Clause 5: The resource configuration method according to Clause 3, further comprising: receiving a second quit instruction from the first virtual machine, wherein the second quit instruction indicates the first virtual machine to reclaim the first thread; and switching the first thread to run the first virtual machine.

Clause 6: The resource configuration method according to Clause 5, wherein switching the first thread to run the first virtual machine comprises: modifying the running identifier of the first thread to identify the first virtual machine; determining whether a current cycle of the computing core corresponding to the first thread has ended; and switching the first thread to run the first virtual machine according to the running identifier when the current cycle has ended.

Clause 7: A resource allocation apparatus, comprising: an acquisition module configured to obtain first computing resources of a first virtual machine, wherein the first computing resources include at least one computing core currently used by the first virtual machine and a first thread running on the computing core; a receiving module configured to receive a computing resource switching instruction, wherein the computing resource switching instruction indicates switching at least one computing core of the first virtual machine to a second virtual machine for use; a determination module configured to determine a computing core to be switched and a corresponding first thread in the first computing resources according to the computing resource switching instruction and the first computing resources; and a switching module configured to switch the first thread to run the second virtual machine.

Clause 8: The resource configuration apparatus according to Clause 7, wherein the first thread is set with a running identifier, wherein the running identifier identifies a virtual machine that the first thread is currently running, and the apparatus further comprises: a modification module configured to modify the running identifier to identify the second virtual machine.

Clause 9: An electronic device, comprising: a memory configured to store a program; A processor configured to run the program stored in the memory to execute the resource configuration method according to any one of Clauses 1 to 6.

Clause 10: A computer-readable storage medium, on which a computer program is stored and is executable by a processor, wherein: when the program is executed by the processor, the resource allocation method according to any one of Clauses 1 to 6 is implemented.

What is claimed is:

1. A method comprising:
obtaining first computing resources of a first virtual machine, wherein the first computing resources include one or more computing cores currently used by the first virtual machine and one or more first threads running on the one or more computing cores;
receiving a computing resource switching instruction, wherein the computing resource switching instruction instructs to switch at least one computing core of the first virtual machine to a second virtual machine for use;
determining a computing core to be switched and a first thread corresponding to the computing core to be switched in the first computing resources according to the computing resource switching instruction and the first computing resources; and
switching the first thread to run the second virtual machine.

2. The method according to claim 1, wherein the computing core to be switched has a binding relationship with the first thread, and switching the first thread to run the second virtual machine comprises:
switching the corresponding first thread to run the second virtual machine and keeping the binding relationship between the first thread and the computing core to be switched unchanged.

3. The method according to claim 1, wherein the first thread is set with a running identifier, wherein the running identifier identifies a virtual machine that the first thread is currently running for, and after the first thread is switched to run the second virtual machine.

4. The method according to claim 3, further comprising:
modifying the running identifier to identify the second virtual machine.

5. The method according to claim 1, further comprising:
receiving a first quit instruction from the first virtual machine, wherein the first quit instruction indicates a temporary occupancy of the first thread by the first virtual machine;
switching the first thread to run the first virtual machine; and
switching the first thread to run the second virtual machine when the temporary occupancy ends.

6. The method according to claim 1, further comprising:
receiving a second quit instruction from the first virtual machine, wherein the second quit instruction indicates the first virtual machine to reclaim the first thread; and
switching the first thread to run the first virtual machine.

7. The method according to claim 6, wherein switching the first thread to run the first virtual machine comprises:
modifying a running identifier of the first thread to identify the first virtual machine;
determining whether a current cycle of the computing core corresponding to the first thread has ended; and
switching the first thread to run the first virtual machine according to the running identifier when the current cycle has ended.

8. One or more computer readable media storing executable instructions that, when executed by one or more processors, cause the one or more processors to perform acts comprising:
obtaining first computing resources of a first virtual machine, wherein the first computing resources include one or more computing cores currently used by the first virtual machine and one or more first threads running on the one or more computing cores;
receiving a computing resource switching instruction, wherein the computing resource switching instruction instructs to switch at least one computing core of the first virtual machine to a second virtual machine for use;
determining a computing core to be switched and a first thread corresponding to the computing core to be switched in the first computing resources according to the computing resource switching instruction and the first computing resources; and
switching the first thread to run the second virtual machine.

9. The one or more computer readable media according to claim 8, wherein the computing core to be switched has a binding relationship with the first thread, and switching the first thread to run the second virtual machine comprises:
switching the first thread to run the second virtual machine and keeping the binding relationship between the first thread and the computing core to be switched unchanged.

10. The one or more computer readable media according to claim 8, wherein the first thread is set with a running identifier, wherein the running identifier identifies a virtual machine that the first thread is currently running for, and after the first thread is switched to run the second virtual machine.

11. The one or more computer readable media according to claim 10, the acts further comprising:
modifying the running identifier to identify the second virtual machine.

12. The one or more computer readable media according to claim 8, the acts further comprising:
receiving a first quit instruction from the first virtual machine, wherein the first quit instruction indicates a temporary occupancy of the first thread by the first virtual machine;
switching the first thread to run the first virtual machine; and
switching the first thread to run the second virtual machine when the temporary occupancy ends.

13. The one or more computer readable media according to claim 8, the acts further comprising:
receiving a second quit instruction from the first virtual machine, wherein the second quit instruction indicates the first virtual machine to reclaim the first thread; and
switching the first thread to run the first virtual machine.

14. The one or more computer readable media according to claim 13, wherein switching the first thread to run the first virtual machine comprises:
modifying a running identifier of the first thread to identify the first virtual machine;
determining whether a current cycle of the computing core corresponding to the first thread has ended; and
switching the first thread to run the first virtual machine according to the running identifier when the current cycle has ended.

15. An apparatus comprising:
one or more processors; and
memory storing executable instructions that, when executed by the one or more processors, cause the one or more processors to perform acts comprising:
obtaining first computing resources of a first virtual machine, wherein the first computing resources include one or more computing cores currently used by the first virtual machine and one or more first threads running on the one or more computing cores;
receiving a computing resource switching instruction, wherein the computing resource switching instruction instructs to switch at least one computing core of the first virtual machine to a second virtual machine for use;
determining a computing core to be switched and a first thread corresponding to the computing core to be switched in the first computing resources according to the computing resource switching instruction and the first computing resources; and
switching the first thread to run the second virtual machine.

16. The apparatus according to claim 15, wherein the computing core to be switched has a binding relationship with the first thread, and switching the first thread to run the second virtual machine comprises:
switching the first thread to run the second virtual machine and keeping the binding relationship between the first thread and the computing core to be switched unchanged.

17. The apparatus according to claim 15, wherein the first thread is set with a running identifier, wherein the running identifier identifies a virtual machine that the first thread is currently running for, and after the first thread is switched to run the second virtual machine, and the acts further comprise: modifying the running identifier to identify the second virtual machine.

18. The apparatus according to claim 15, the acts further comprising:
receiving a first quit instruction from the first virtual machine, wherein the first quit instruction indicates a temporary occupancy of the first thread by the first virtual machine;
switching the first thread to run the first virtual machine; and
switching the first thread to run the second virtual machine when the temporary occupancy ends.

19. The apparatus according to claim 15, the acts further comprising:
receiving a second quit instruction from the first virtual machine, wherein the second quit instruction indicates the first virtual machine to reclaim the first thread; and
switching the first thread to run the first virtual machine.

20. The apparatus according to claim 19, wherein switching the first thread to run the first virtual machine comprises:
modifying a running identifier of the first thread to identify the first virtual machine;
determining whether a current cycle of the computing core corresponding to the first thread has ended; and
switching the first thread to run the first virtual machine according to the running identifier when the current cycle has ended.
